(19) United States
(12) Patent Application Publication
(10) Pub. No.: US 2026/0046431 A1
(43) Pub. Date: Feb. 12, 2026

(54) Method and Apparatus for Video Frame Synthesis

(71) Applicant: HUAWEI TECHNOLOGIES CO., LTD., Shenzhen (CN)

(72) Inventors: Nicola Giuliani, Munich (DE); Atanas Boev, Munich (DE); Elena Alexandrovna Alshina, Munich (DE)

(73) Assignee: HUAWEI TECHNOLOGIES CO., LTD., Shenzhen (CN)

(21) Appl. No.: 19/362,147

(22) Filed: Oct. 17, 2025

Related U.S. Application Data
(63) Continuation of application No. PCT/EP2023/067474, filed on Jun. 27, 2023.

(51) Int. Cl. H04N 19/42; H04N 19/124; H04N 19/136; H04N 19/172; H04N 19/176

(52) U.S. Cl. CPC H04N 19/42; H04N 19/124; H04N 19/136; H04N 19/172; H04N 19/176

(57) ABSTRACT

It is provided a method of video frame synthesis by means of a convolutional neural network comprising an encoder comprising at least one first mask unit and a decoder comprising at least one second mask unit. The method includes: generating by the at least one first mask unit first data corresponding to only first sub-portions of a first video frame taken at a first time instance and second data corresponding to only second sub-portions of a second video frame taken at a second time instance, generating by the encoder a first pyramid of features based on the first data and a second pyramid of features based on the second data and generating by the decoder a synthesized third video frame for a third time instance between the first and second time instances based on the generated pyramids of features and by means of the at least one second mask unit.

### CROSS-REFERENCE TO RELATED APPLICATIONS

This application is a continuation of International Application No. PCT/EP2023/067474, filed on Jun. 27, 2023, the disclosure of which is hereby incorporated by reference in its entirety.

### TECHNICAL FIELD

Embodiments of the present disclosure generally relate to the field of encoding and decoding databased on a neural network architecture. In particular, some embodiments relate to methods and apparatuses for synthesizing video frames based on convolutional neural networks.

### BACKGROUND

Hybrid image and video codecs have been used for decades to compress image and video data. In such codecs, signal is typically encoded block-wisely by predicting a block and by further coding only the difference between the original bock and its prediction. In particular, such coding may include transformation, quantization and generating the bitstream, usually including some entropy coding. Typically, the three components of hybrid coding methods-transformation, quantization, and entropy coding—are separately optimized. Modern video compression standards like High-Efficiency Video Coding (HEVC), Versatile Video Coding (VVC) and Essential Video Coding (EVC) also use transformed representation to code residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approached have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

The present disclosure provides methods and apparatuses to improve the synthesis of video frames, in particular, for video compression or frame rate up-conversion.

According to a first aspect, the present disclosure relates to a method of video frame synthesis by means of a convolutional neural network. The convolutional neural network comprises an encoder and a decoder, wherein the encoder comprises at least one first mask unit and the decoder comprises at least one second mask unit. The method includes the steps of: generating by the at least one first mask unit first data corresponding to only one or more first sub-portions of a first video frame taken at a first time instance and second data corresponding to only one or more second sub-portions of a second video frame taken at a second time instance different from the first time instance:
generating by the encoder a first pyramid of features based on the first data and a second pyramid of features based on the second data; and
generating by the decoder a synthesized third video frame for a third time instance between the first and second time instances based on the generated first and second pyramids of features and by means of the at least one second mask unit.

Each pyramid of features comprises different levels of features with different numbers of feature channels and for each level of features an individual mask unit may be employed. It is noted that the mask units may be applied to the feature tensors (in this case, the first and second data comprise the feature tensors) or pixelwise to the first and second video frames.

According to the method of the first aspect, intermediate video frame synthesis by means of neural network generated synthetic video frames is combined with dynamic/conditional convolution. Employment of the mask units allows for the dynamic/conditional convolution wherein convolutional filters of the convolutional neural network are not to be applied to every region (pixel) of the first and second video frames but rather to sub-portions of the first and second video frames only. Thereby, the overall processing can be significantly accelerated and the demand for memory space can be reduced.

For example, in the context of inter prediction coding regions of the video frames to be processed that do not show significant motion can be neglected based on the application of the mask units. In general, based on content the mask units may only provide only sub-portions of the video frames for convolution processing that are of interest, for example, excluding static background portions.

The foregoing and other embodiments can each optionally include one or more of the following features, alone or in combination.

In a possible implementation, the at least one first and second mask units are trained for obtaining a target sparsity of the first data with respect to the first video frame and the second data with respect to the second video frame. The target sparsity defines the reduction of information from the entire video frames to the data to be processed by the convolutional filters of the neural network. For example, the at least one first and second mask units are trained based on content of training images and, thus, a content based conditional convolution can be achieved wherein such sub-portions of the video frames that are to be processed can be neglected that are of no relevance in the particular actual application (for example, static objects and background).

According to an implementation, the method of the first aspect and implementations thereof further comprises determining the target sparsity based on a quantization parameter used for compressing the first and second video frames. The same quantization parameter or different quantization parameters may be used for the first and second video frames. In the context of video compression the quantization parameter represents a measure of complexity of partitions of the video frames wherein large quantization parameters can be used for coding partitions with relatively low complexity and small quantization parameters can be used for coding partitions with relatively high complexity. Thus, the quantization parameter can be suitably used for controlling the reduction of data to be processed by the convolutional filters of the neural network.

According to an implementation, the target sparsity depends on at least one of the number of objects present in the first and second video frames, the degree of motion of the objects between the first and second video frames, the number of image partitions into which the first and second video frames are partitioned and a level of compression of the first and second video frames. Such quantities also can be suitably used for controlling the reduction of data to be processed by the convolutional filters of the neural network.

The method of the first aspect and any implementation thereof can be implemented in (performed by) a video encoder device and a video decoder device. Herein, it has to be differentiated between a) the encoder and the video encoder device and b) the decoder and the video decoder device, respectively. The video encoder device transmits encoded data to the video decoder device and the video decoder device decodes the encoded data. Each of the video encoder device and video decoder device comprises a copy of the convolutional neural network comprising an encoder for feature extraction and a decoder for frame synthesis.

According to an implementation, the method further comprises selecting the target sparsity out of a plurality of pre-defined target sparsity levels (ratios) by a video encoder device comprising copies of the convolutional neural network for each of the pre-defined target sparsity levels, signaling the selected target sparsity to a video decoder device comprising copies of the convolutional neural network for each of the pre-defined target sparsity levels and processing by the video decoder device the first and second video frames based on the signaled target sparsity. According to this implementation a set of pre-trained synthesizing neural networks is used by the video encoder device and the video decoder device, respectively, and the video decoder device is explicitly informed by the video encoder device about the sparsity level that is to be used in order to decode the encoded data transmitted by the video encoder device. Signaling the target sparsity allows for application of the method in a wide variety of video compression schemes.

According to an alternative implementation, no signaling of the target sparsity is needed but rather the method further comprises determining the target sparsity by both a video encoder device comprising copies of the convolutional neural network for each of pre-defined target sparsity levels and by a video decoder device comprising copies of the convolutional neural network for each of pre-defined target sparsity levels based on at least one of a) a quantization parameter used for compression of the first and second video of frames and b) a number of blocks into which the first and second video frames are partitioned.

For example, the target sparsity level SR_{estimated} is determined by the video encoder device and the video decoder device based on the formula

$${SR}_{e s t i m a t e d} = k ( \frac{{NB}_{0}^{n} + {NB}_{1}^{n}}{2 {NB}_{max}} ) + ( {SR}_{max} - k ) ( \frac{Q {P}_{0}^{n} + Q {P}_{1}^{n}}{2 Q {P}_{max}} )$$

wherein

$${NB}_{0}^{n} , {NB}_{1}^{n}$$

is the number of blocks into which the first and second video frames are partitioned, respectively, NBₘₐₓ is the maximum possible number of blocks into which the first and second video frames can be partitioned depending on the resolution of the first and second video frame and possible block sizes, SRₘₐₓ is a pre-defined maximum target sparsity level SR_{estimated},

$$Q {P}_{0}^{n} + Q {P}_{1}^{n}$$

are the quantization parameter values for the first and the second video frames, respectively, QPₘₐₓ is a pre-defined maximum quantization parameter value and k is a pre-defined weighting coefficient (for example, between 0 and 1). Such kind of parameterization of the target sparsity may be suitable for controlling the reduction of data to be processed by the convolutional filters of the neural network.

In the above-describe implementations, the plurality of pre-defined target sparsity levels may comprise a number of sparsity levels between 10% and 90% sparsity of the first data with respect to the first video frame and the second data with respect to the second video frame, wherein neighbored sparsity levels are spaced with respect to each other by intervals of at least 10% sparsity of the first data with respect to the first video frame and the second data with respect to the second video frame. A large range of sparsity levels can, thus, be covered, wherein intervals significantly smaller than 10% would not increase accuracy of frame synthesis.

According to a third alternative, the target sparsity is neither signaled nor estimated based on a quantization parameter and/or a number of partitioning blocks and there is no need to provide for a number of pre-trained copies of the neural network for different sparsity levels. Rather, the method further comprises receiving by the at least one first mask unit at least one of a) a quantization parameter used for compression of the first and second video of frames and b) a number of blocks into which the first and second video frames are partitioned and determining by the at least one first mask unit the target sparsity based on the received at least one of a) the quantization parameter used for compression of the first and second video of frames and b) the number of blocks into which the first and second video frames are partitioned.

Thus, according to this implementation the neural network is conditioned by an additional input channel (control parameters) in form of the quantization parameter and/or the number of partitioning blocks. This kind of implementation, allows operation without the need to update the neural network weights on the fly and adaptation of the sparsification to the actual contents of the reference frames.

According to an implementation, generating the synthesized third video frame comprises conjointly refining bilateral intermediate flow fields together with a first intermediate pyramid of features reconstructed based on the first pyramid of features and a second intermediate pyramid of features reconstructed based on the second pyramid of features. Thus, the video frame synthesis may be suitably based on flow-based video frame interpolation that may result in effective and accurate synthesis results.

The method of the first aspect and any implementation thereof may be suitably used (both on a video encoder device side and a video decoder device side) in the context of video compression and frame rate up-conversion, for example.

According to a second aspect, it is provided a method of video compression comprising the steps of the method according to the first aspect and any implementation thereof, wherein the synthesized third video frame is saved as an S frame in a decoded picture buffer or is added to a list of reference pictures used for intra prediction or inter prediction.

According to a third aspect, it is provided a method of frame rate up-conversion comprising the steps of the method according to the first aspect and any implementation thereof, wherein the synthesized third video frame is used for increasing a frame rate of a transmitted video comprising the first and second video frames.

According to a fourth aspect, it is provided a computer program stored on a non-transitory medium comprising a code which when executed on one or more processors performs the steps of the method according to the first aspect and any implementation thereof or the method according to the second aspect or the method according to the third aspect.

According to a fifth aspect, it is provided a processing apparatus (for example, a video encoder device or a video decoder device) for video frame synthesis, comprising one or more processors and a non-transitory computer-readable storage medium coupled to the one or more processors and storing programming for execution by the one or more processors, wherein the programming, when executed by the one or more processors, configures the apparatus to carry out the method according to the first aspect and any implementation thereof or the method according to the second aspect or the method according to the third aspect.

According to a sixth aspect, it is provided a processing apparatus (for example, a video encoder device or a video decoder device) for video frame synthesis comprising a convolutional neural network. The convolutional neural network comprises an encoder and a decoder, the encoder comprising at least one first mask unit and the decoder comprising at least one second mask unit. The at least one first mask unit is configured for generating first data corresponding to only one or more first sub-portions of a first video frame taken at a first time instance and second data corresponding to only one or more second sub-portions of a second video frame taken at a second time instance different from the first time instance. The encoder is configured for generating a first pyramid of features based on the first data and a second pyramid of features based on the second data and the decoder is configured for generating a synthesized third video frame for a third time instance between the first and second time instances based on the generated first and second pyramids of features and by means of the at least one second mask unit.

The processing apparatus according to the sixth aspect and any implementation thereof provides the same or similar advantages described above with reference to the method according to the first aspect and any implementation thereof.

According to an implementation of the processing apparatus of the first aspect, the at least one first and second mask units are trained for obtaining a target sparsity of the first data with respect to the first video frame and the second data with respect to the second video frame.

For example, the at least one first and second mask units are trained based on content of training images. The target sparsity may be determined based on a quantization parameter used for compressing the first and second video frames. The target sparsity may depend on at least one of the number of objects present in the first and second video frames, the degree of motion of the objects between the first and second video frames, the number of image partitions into which the first and second video frames are partitioned and a level of compression of the first and second video frames.

According to another implementation, the decoder of the processing apparatus is configured for generating the synthesized third video frame by conjointly refining bilateral intermediate flow fields together with a first intermediate pyramid of features reconstructed based on the first pyramid of features and a second intermediate pyramid of features reconstructed based on the second pyramid of features.

According to a seventh aspect, it is provided a video encoder device comprising copies of the processing apparatus according to the sixth aspect or any implementation thereof, each of the copies comprising the convolutional neural network for a different one of pre-defined target sparsity levels, wherein the video encoder device is configured for selecting the target sparsity out of the plurality of pre-defined target sparsity levels and signaling the selected target sparsity to a video decoder device.

According to an eighth aspect, it is provided a video decoder device comprising copies of the processing apparatus according to the sixth aspect or any implementation thereof, each of the copies comprising the convolutional neural network for a different one of pre-defined target sparsity levels, wherein the video decoder device is configured for processing the first and second video frames based on a target sparsity received from an encoder device.

According to a ninth aspect, it is provided a video encoder device comprising copies of the processing apparatus according to the sixth aspect or any implementation thereof, each of the copies comprising the convolutional neural network for a different one of pre-defined target sparsity levels, wherein the video encoder device is configured for determining the target sparsity based on at least one of a) a quantization parameter used for compression of the first and second video of frames and b) a number of blocks into which the first and second video frames are partitioned. According to an implementation, this video encoder device is configured for determining the target sparsity level SR_{estimated} based on the formula

$${SR}_{e s t i m a t e d} = k ( \frac{{NB}_{0}^{n} + {NB}_{1}^{n}}{2 {NB}_{max}} ) + ( {SR}_{max} - k ) ( \frac{Q {P}_{0}^{n} + Q {P}_{1}^{n}}{2 Q {P}_{max}} )$$

wherein

$${NB}_{0}^{n} , {NB}_{1}^{n}$$

is the number of blocks into which the first and second video frames are partitioned, respectively, NBₘₐₓ is the maximum possible number of blocks into which the first and second video frames can be partitioned depending on the resolution of the first and second video frame and possible block sizes, SRₘₐₓ is a pre-defined maximum target sparsity level SR_{estimated},

$$Q {P}_{0}^{n} + Q {P}_{1}^{n}$$

are the quantization parameter values for the first and the second video frames, respectively, QPₘₐₓ is a pre-defined maximum quantization parameter value and k is a pre-defined weighting coefficient.

According to a tenth aspect, it is provided a video decoder device comprising copies of the processing apparatus according to the sixth aspect or any implementation thereof, each of the copies comprising the convolutional neural network for a different one of pre-defined target sparsity levels, wherein the video encoder device is configured for determining the target sparsity based on at least one of a) a quantization parameter used for compression of the first and second video of frames and b) a number of blocks into which the first and second video frames are partitioned. According to an implementation, this video decoder device is configured for determining the target sparsity level SR_{estimated} based on the formula

$${SR}_{e s t i m a t e d} = k ( \frac{{NB}_{0}^{n} + {NB}_{1}^{n}}{2 {NB}_{max}} ) + ( {SR}_{max} - k ) ( \frac{Q {P}_{0}^{n} + Q {P}_{1}^{n}}{2 Q {P}_{max}} )$$

wherein

$${NB}_{0}^{n} , {NB}_{1}^{n}$$

is the number of blocks into which the first and second video frames are partitioned, respectively, NBₘₐₓ is the maximum possible number of blocks into which the first and second video frames can be partitioned depending on the resolution of the first and second video frame and possible block sizes, SRₘₐₓ is a pre-defined maximum target sparsity level SR_{estimated},

$${QP}_{0}^{n} + {QP}_{1}^{n}$$

are the quantization parameter values for the first and the second video frames, respectively, QPₘₐₓ is a pre-defined maximum quantization parameter value and k is a pre-defined weighting coefficient.

According to another implementation, the at least one first mask unit of the processing according to the sixth aspect or any implementation thereof is configured for i) receiving at least one of a) a quantization parameter used for compression of the first and second video of frames and b) a number of blocks into which the first and second video frames are partitioned and ii) determining the target sparsity based on the received at least one of a) the quantization parameter used for compression of the first and second video of frames and b) the number of blocks into which the first and second video frames are partitioned.

According to an eleventh aspect, it is provided a video compression apparatus, comprising the processing apparatus according to the sixth aspect or any implementation thereof or the video encoder device according to the seventh or ninth aspect or any implementation thereof or the video decoder device according to the eighth or tenth aspect or any implementation thereof and configured for saving the synthesized third video frame as an S frame in a decoded picture buffer or adding the synthesized third video frame to a list of reference pictures used for intra prediction or inter prediction.

According to a twelfth aspect, it is provided a video frame rate up-conversion apparatus, comprising the processing apparatus according to the sixth aspect or any implementation thereof or the video decoder device according to the eighth or tenth aspect or any implementation thereof and configured for increasing a frame rate of a transmitted video comprising the first and second video frames by means of the synthesized third video frame.

According to a thirteenth aspect, the present disclosure relates to a video stream decoding apparatus, including a processor and a memory. The memory stores instructions that cause the processor to perform the method according to the first aspect or any implementation thereof.

According to a fourteenth aspect, the present disclosure relates to a video stream encoding apparatus, including a processor and a memory. The memory stores instructions that cause the processor to perform the method according to the first aspect or any implementation thereof.

According to a fifteenth aspect, a computer-readable storage medium having stored thereon instructions that when executed cause one or more processors to encode video data is proposed. The instructions cause the one or more processors to perform the method according to the first or second aspect or any possible embodiment of the first aspect or any implementation thereof.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which

FIG. 1 is a schematic drawing illustrating channels processed by layers of a neural network;

FIG. 2 is a schematic drawing illustrating an autoencoder type of a neural network:

FIG. 3A is a schematic drawing illustrating a network architecture for encoder and decoder side including a hyperprior model:

FIG. 3B is a schematic drawing illustrating a general network architecture for encoder side including a hyperprior model:

FIG. 3C is a schematic drawing illustrating a general network architecture for decoder side including a hyperprior model:

FIG. 4 is a schematic drawing illustrating a network architecture for encoder and decoder side including a hyperprior model:

FIG. 5 is a block diagram illustrating a structure of a cloud-based solution for machine based tasks such as machine vision tasks:

FIG. 6A is a block diagram illustrating end-to-end video compression framework based on a neural networks:

FIG. 6B is a block diagram illustrating some details of application of a neural network for motion field compression:

FIG. 6C is a block diagram illustrating some details of application of a neural network for motion compensation:

FIG. 7 illustrates a convolutional neural network architecture for intermediate video frame synthesis according to the art:

FIG. 8 illustrates a convolutional neural network architecture implementing dynamic convolutions according to the art:

FIG. 9 illustrates a processing apparatus comprising a convolutional neural network architecture for intermediate video frame synthesis and implementing dynamic convolutions according to an embodiment:

FIG. 10 illustrates approaches for implementing dynamic convolutions in the processing apparatus illustrated in FIG. 9;

FIG. 11A illustrates a processing apparatus comprising a convolutional neural network architecture for intermediate video frame synthesis based on hybrid video codecs and implementing dynamic convolutions according to an embodiment:

FIG. 11B illustrates a processing apparatus comprising a convolutional neural network architecture for intermediate video frame synthesis based on hybrid video codecs and implementing dynamic convolutions according to another embodiment:

FIG. 11C illustrates a processing apparatus comprising a convolutional neural network architecture for intermediate video frame synthesis based on hybrid video codecs and implementing dynamic convolutions according to another embodiment:

FIG. 12 is a flow chart illustrating a method of video frame synthesis by means of a convolutional neural network comprising an encoder and a decoder according to an embodiment:

FIG. 13 is a block diagram illustrating an example of a processing apparatus according to an embodiment:

FIG. 14 is a block diagram showing an example of a video coding system configured to implement embodiments of the present disclosure:

FIG. 15 is a block diagram showing another example of a video coding system configured to implement embodiments of the present disclosure:

FIG. 16 is a block diagram illustrating an example of an encoding apparatus or a decoding apparatus:

FIG. 17 is a block diagram illustrating another example of an encoding apparatus or a decoding apparatus:

FIG. 18 is a block diagram illustrating another example of an encoding apparatus or a decoding apparatus.

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various embodiments and/or aspects described herein may be combined with each other, unless noted otherwise.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their lavers.

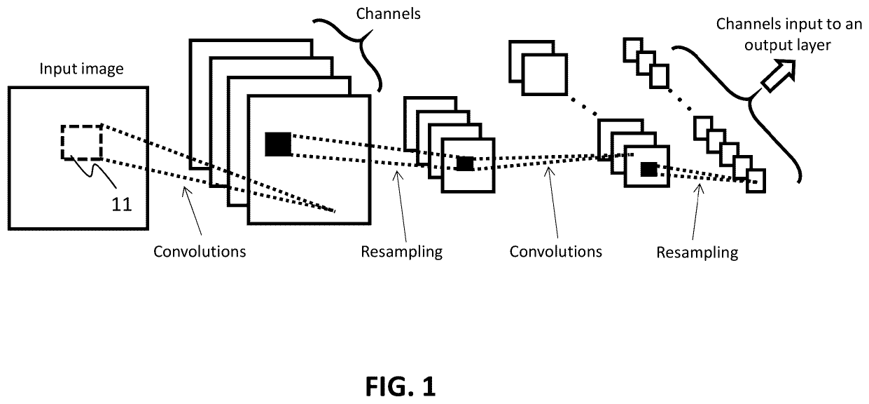

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is usually a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at an index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or (2-norm pooling. Average pooling was often used historically but has recently fallen out of favor compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

Leaky ReLU(x)=max(0,x)+negative_slope*min(0,x), or

$$LeakyReLU ( x ) = \{ \begin{matrix}x , & if x \geq 0 \\ negative\_slope * x , & otherwise\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an implementation, the output layer is a fully connected layer.

### Autoencoders and Unsupervised Learning

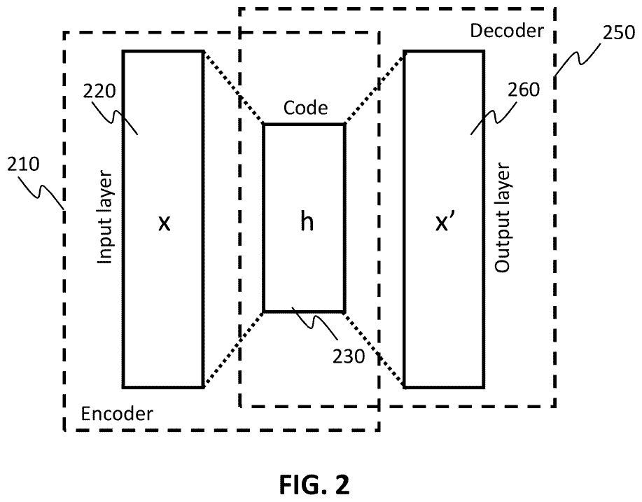

An autoencoder is a type of artificial neural network used to learn efficient data codings in an unsupervised manner. A schematic drawing thereof is shown in FIG. 2. The autoencoder includes an encoder side 210 with an input x input into an input layer of an encoder subnetwork 220 and a decoder side 250 with output x′ output from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and an estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{K L} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, 1). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods-transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

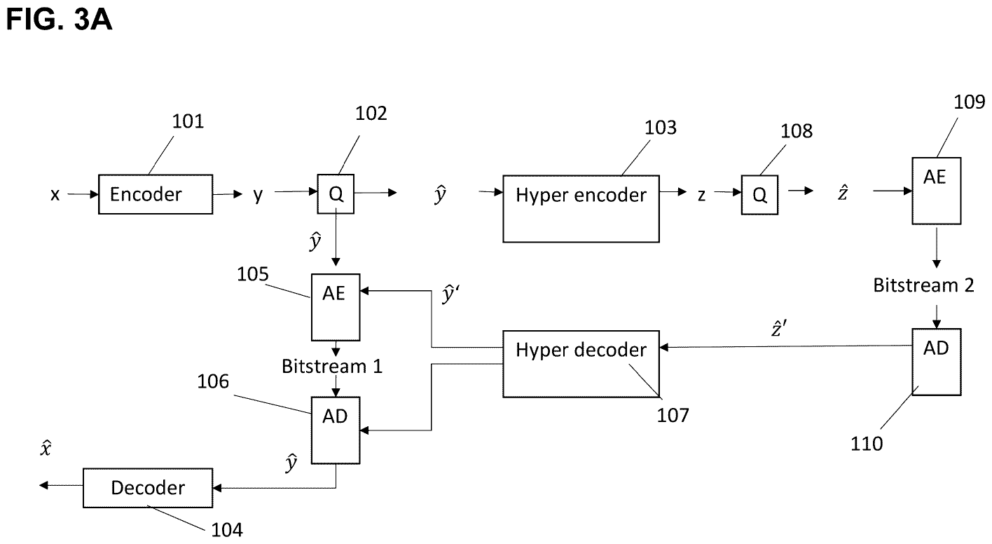

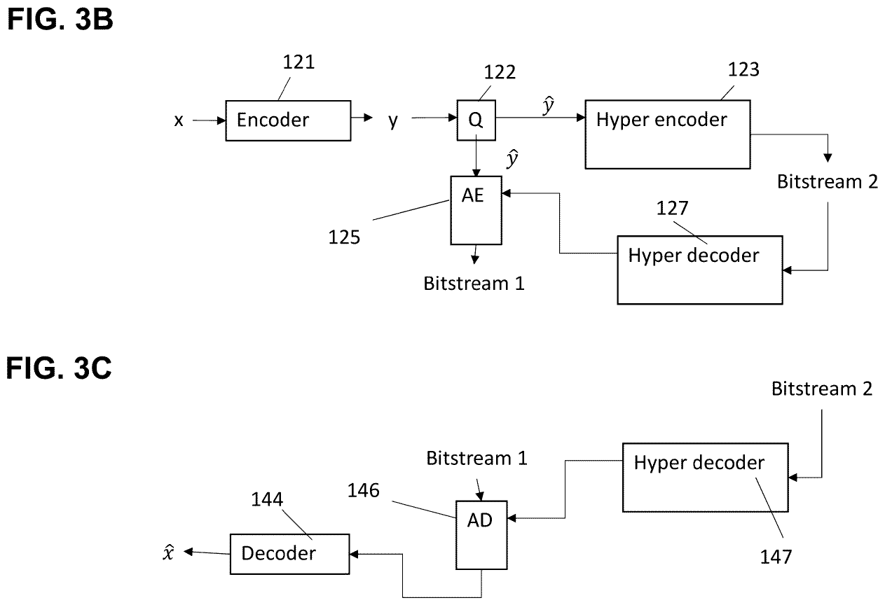

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (x) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in an implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

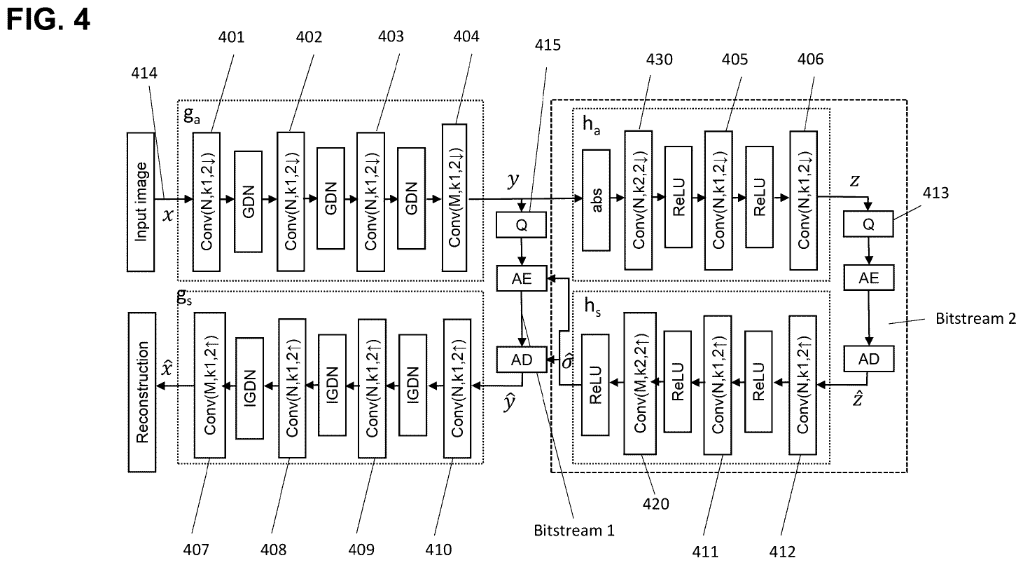

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers 2 from the compressed signal. It then uses hₛ to obtain ŷ, which provides it with the correct probability estimates to successfully recover y as well. It then feeds ŷ into gₛ to obtain the reconstructed image.

The layers that include downsampling is indicated with the downward arrow in the layer description. The layer description “Conv N,k1,2↓” means that the layer is a convolution laver, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling lavers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

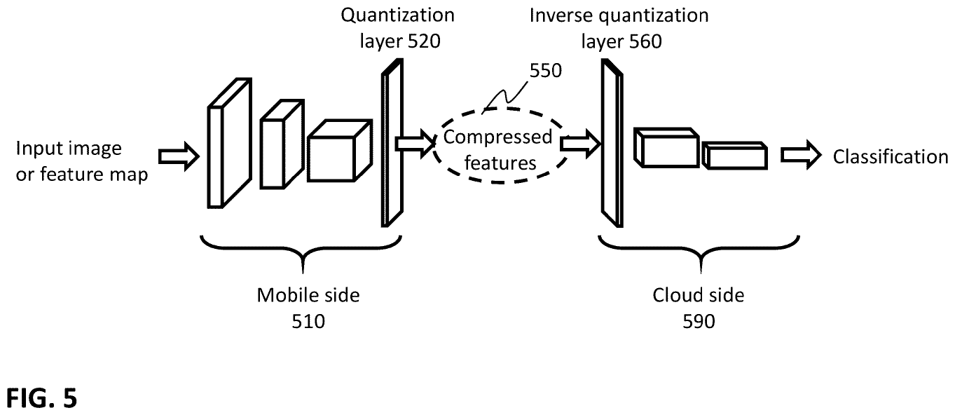

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes: for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

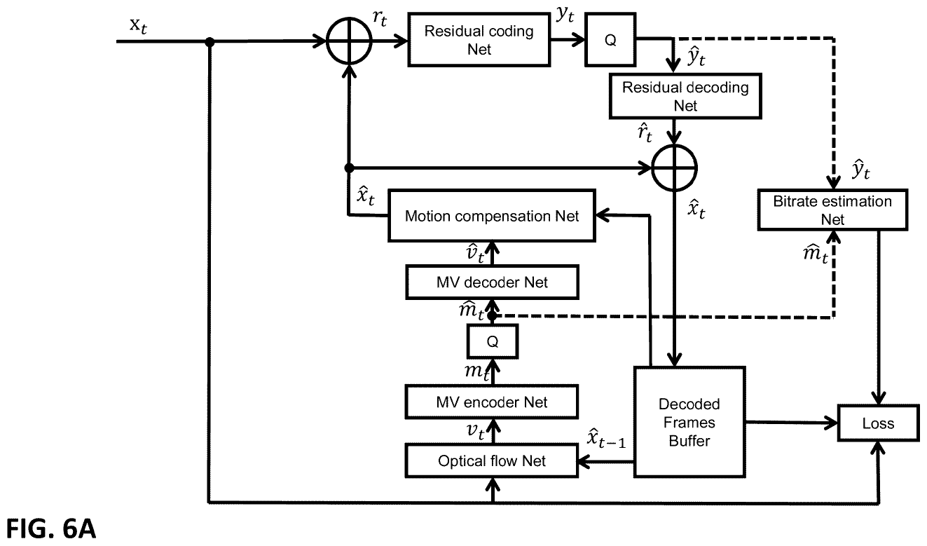

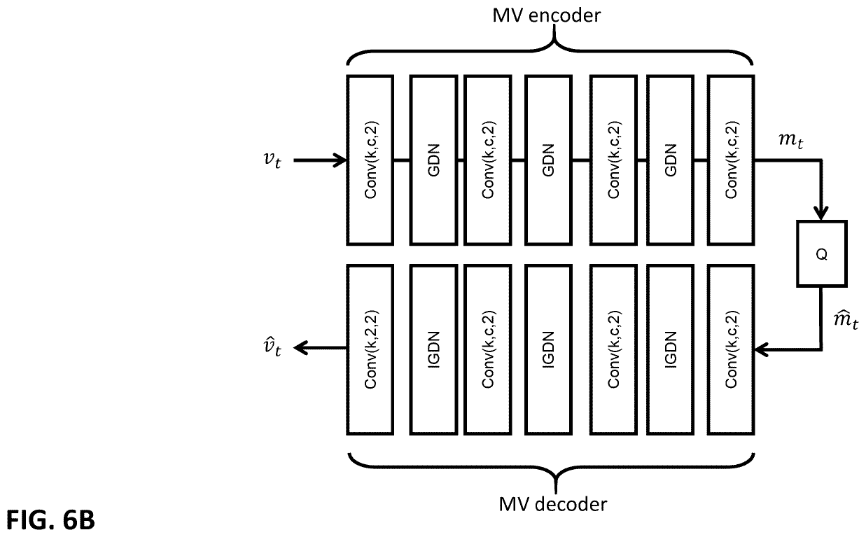

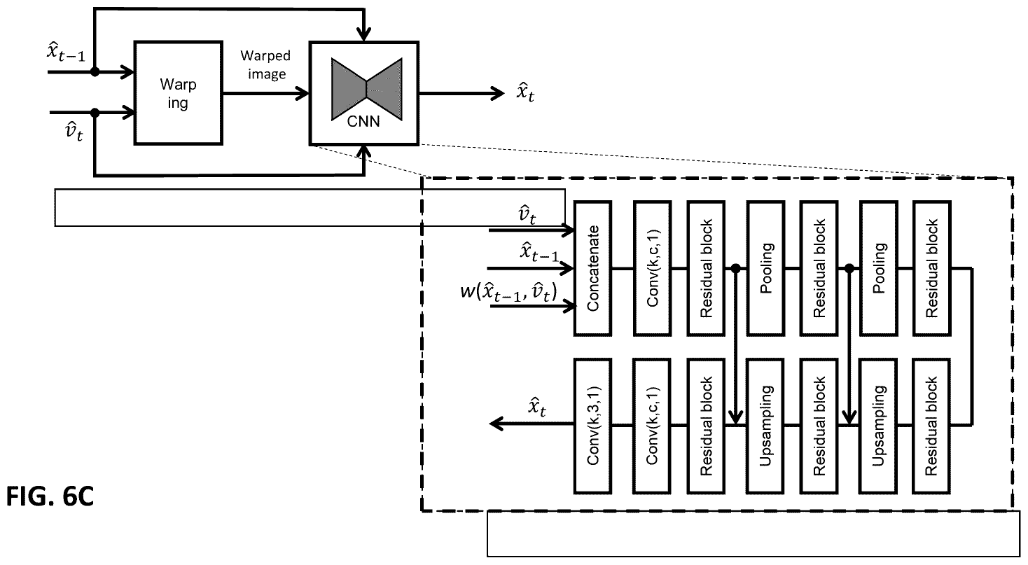

Such encoder is illustrated in FIG. 6A. In particular, FIG. 6A shows an overall structure of end-to-end trainable video compression framework. In order to compress motion information, a CNN was designated to transform the optical flow vₜ to the corresponding representations mₜ suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the art autoencoder based approach to compression are also valid for machine vision tasks.

### Network Training

### Loss Function

The loss function may include a plurality of items. For an image encoding task, loss items related to reconstruction quality generally include an L1 loss, an L2 loss (or referred to as an MSE loss), an MS-SSIM loss, a VGG loss, an LPIPS loss, a GAN loss, and the like, and further include loss items related to bitstream size.

The L1 loss calculates an average value of errors between points to obtain an L1 loss value. The L1 loss function can better evaluate reconstruction quality of a structured region in an image.

Mean squared error (MSE) loss: a function for measuring a distance between two pieces of data. In this embodiment of this application, the MSE loss is also referred to as the L2 loss function. An average value of squares of errors between points is calculated to obtain an L2 loss value. The MSE loss may also be used to calculate a PSNR. The L2 loss is also a pixel-level loss. The L2 loss function can also better evaluate reconstruction quality of a structured region in an image. If the L2 loss function is used to optimize an image encoding and decoding network, an optimized image encoding and decoding network can achieve a higher PSNR.

Structural similarity index measure (SSIM): an objective criterion for evaluating image quality. Higher SSIM indicates better image quality. In this embodiment of this application, structural similarity between two images at a scale is calculated to obtain an SSIM loss value. The SSIM loss is a loss based on an artificial feature. Compared with the L1 loss function and the L2 loss function, the SSIM loss function can more objectively evaluate image reconstruction quality, that is, evaluate a structured region and an unstructured region of an image in a more balanced manner. If the SSIM loss function is used to optimize an image encoding and decoding network, an optimized image encoding and decoding network can achieve a higher SSIM.

Multi-scale structural similarity index measure (multi-scale SSIM, MS-SSIM): an objective criterion for evaluating image quality. Higher SSIM indicates better image quality. Multi-layer low-pass filtering and downsampling are separately performed on two images to obtain image pairs at a plurality of scales. A contrast map and structure information are extracted from an image pair at each scale, and SSIM loss values at the corresponding scale are obtained based on the contrast map and the structure information. Luminance information of an image pair at a smallest scale is extracted, and a luminance loss value at the smallest scale is obtained based on the luminance information. Then, the SSIM loss values and the luminance loss value at the plurality of scales are aggregated in a manner to obtain an MS-SSIM loss value, for example, an aggregation manner in Equation (1):

$$MS - SSIM ( x , y ) = {[ {l}_{M} ( x , y ) ]}^{{a}_{M}} * {\prod }_{j = 1}^{M} {{[ {c}_{j} ( x , y ) ]}^{{β}_{j}} [ {s}_{j} ( x , y ) ]}^{{γ}_{j}} \qquad ( 1 )$$

In Equation (1), the loss values at all the scales are aggregated in a manner of exponential power weighting and multiplication. Herein, x and y separately indicate the two images, l indicates the loss value based on the luminance information, c indicates the loss value based on the contrast map, and s indicates the loss value based on the structure information. A subscript j=1, . . . , M indicates M scales that separately correspond to total M times of downsampling, j=1 indicates a largest scale, and j=M indicates the smallest scale. The superscripts α, β, and γ each indicate an exponential power of a corresponding term.

The MS-SSIM loss function and the SSIM loss function have similar better image evaluation effect. Compared with the L1 loss and the L2 loss, the MS-SSIM loss for optimization can improve subjective experience of human eyes and meet objective evaluation indicators. If the MS-SSIM loss function is used to optimize an image encoding and decoding network, an optimized image encoding and decoding network can achieve a higher MS-SSIM.

Visual geometry group (VGG) loss: VGG is the name of an organization that designs a CNN network and names it VGG network. An image loss value determined based on a VGG network is referred to as a VGG loss value. A process of determining a VGG loss value is substantially as follows: A feature of an original image before compression and a feature of a decompressed reconstructed image at a scale (for example, a feature map obtained through convolution calculation at a layer) are separately extracted by using a VGG network, and then a distance between the feature of the original image and the feature of the reconstructed image at this scale is calculated to obtain the VGG loss value. This process is considered as a process of determining a VGG loss value according to a VGG loss function. The VGG loss function focuses on improving reconstruction quality of texture.

Learned perceptual image patch similarity (LPIPS) loss: an enhanced VGG loss. A multi-scale characteristic is introduced into a process of determining an LPIPS loss value. The process of determining an LPIPS loss value is substantially as follows: Features of the two images at a plurality of scales are separately extracted by using a VGG network, then a distance between the features of the two images at each scale is calculated to obtain a plurality of VGG loss values, and then weighted summation is performed on the plurality of VGG loss values to obtain the LPIPS loss value. This process is considered as a process of determining an LPIPS loss value according to an LPIPS loss function. Similar to the VGG loss function, the LPIPS loss function also focuses on improving reconstruction quality of texture.

Generative adversarial network loss: Features of two images are separately extracted by using a discriminator (also referred to as a discriminator) included in a GAN, and a distance between the features of the two images is calculated to obtain a generative adversarial network loss value. This process is considered as a process of determining a GAN loss value according to a GAN loss function. The GAN loss function also focuses on improving reconstruction quality of texture. The GAN loss includes at least one of a standard GAN loss, a relative GAN loss, a relative average GAN loss, a least squares GAN loss, and the like.

Perceptual loss: a perceptual loss in a broad sense and a perceptual loss in a narrow sense. In this embodiment of this application, the perceptual loss in a narrow sense is used as an example for description. The VGG loss and the LPIPS loss may be considered as a perceptual loss in a narrow sense. However, in another embodiment, a loss calculated based on a depth feature extracted from an image may be considered as a perceptual loss in a broad sense. The perceptual loss in a broad sense may include the perceptual loss in a narrow sense, and may further include a loss, for example, the foregoing GAN loss. The perceptual loss function makes the reconstructed image better satisfy subjective experience of human eyes, but may decrease the PSNR and the MS-SSIM.

### Functional Modules

### Variable Bitrate Module

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value. The scaling factor may be preset. Different quality levels or quantization parameters correspond to different target gain values. If the output of the encoding network is scaled to a smaller value, a bitstream size may be decreased. Otherwise, the bitstream size may be increased.

### Color Format Transform

RGB and YUV are common color spaces. Conversion between RGB and YUV may be performed according to an equation specified in standards such as CCIR 601 and BT.709.

### Separate Structure for Luma and Chroma

Some VAE-based codecs use the YUV color space as an input of an encoder and an output of a decoder. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

In the present disclosure, a parameter is a value used in an operation process of each layer forming a neural network, and for example, may include a weight used when an input value is applied to a certain operation expression. Here, the parameter may be expressed in a matrix form. The parameter is a value set as a result of training, and may be updated through separate training data when necessary.

The present disclosure presents methods and apparatuses for video frame synthesis based on convolutional neural networks. Due to conditional/dynamic convolution the coding process can be accelerated and simplified as compared to the art. Particularly, according to embodiments video frame interpolation based on optical flow can be combined with conditional/dynamic convolution. Application of dynamic convolution in the context of video frame synthesis is introduced herein for the first time. Video frame interpolation based on optical flow comprises estimating the optical flow between a target frames and input frames, warping the input frames or corresponding features frames (tensors) by predicted flow fields for spatial alignment and refining the warped input or feature frames to generate the target frame by a synthesis network. The present disclosure is implementable in any neural network for frame synthesis. In contrast to common frame synthesis networks, in which all operations are executed on all spatial positions, in this spatial operations are selectively executed based on the content of the input. During inference the proposed neural network can adapt to the content and provide different levels of computational effort.

According to a particular embodiment the encoder-decoder based network introduced as IFRNet in a paper by L. Kong et al. entitled, “IFRNet: Intermediate Feature Refine Network for Efficient Frame Interpolation”, Proceedings of the IEEE/CVF Conference on Computer Vision and Pattern Recognition, June 22, pages 1969-1978, can be combined with conditional/dynamic convolution. The concept of conditional/dynamic convolution was introduced by T. Verelst and T. Tuytelaars in a paper entitled “Dynamic Convolutions: Exploiting Spatial Sparsity for Faster Inference”, IEEE Conference on Computer Vision and Pattern Recognition, June 2020, pages 2320-2329, in the context of human pose estimation.

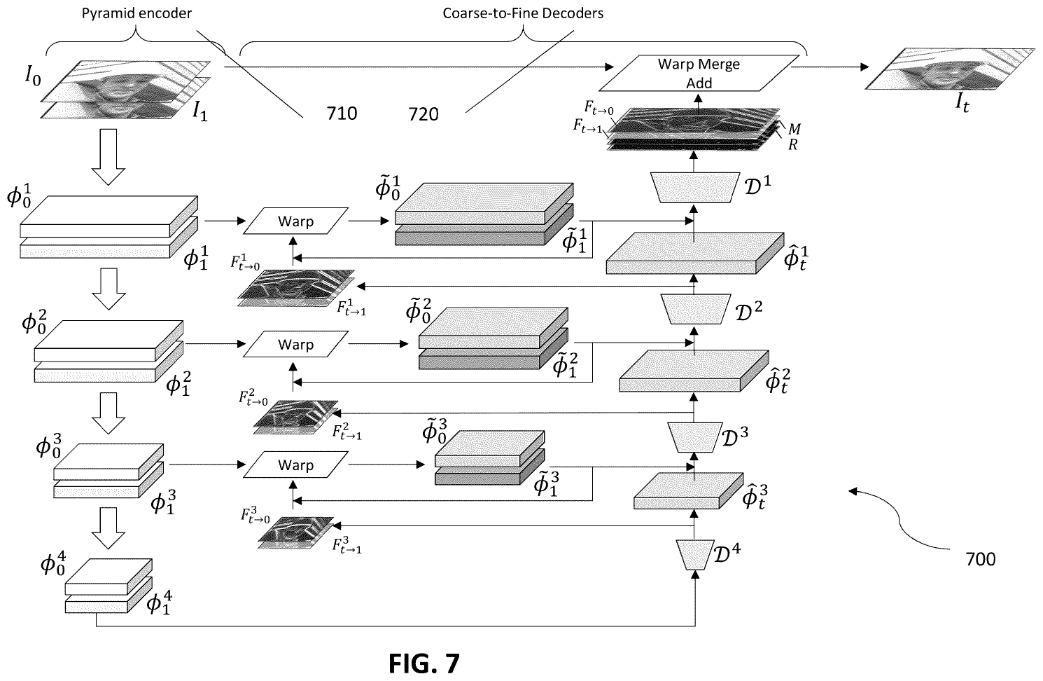

FIG. 7 illustrates the IFRNet architecture 700 that can be employed in an embodiment. IFRNet takes two frames I₀ and I₁ with dimensions W×H×3 and time steps 0 and t=1 as inputs and outputs an intermediate frame with dimensions W×H×3 at intermediate time step t ϵ [0, 1]. The IFRNet architecture 700 comprises a pyramid encoder 710 and coarse-to-fine decoders 720, D¹ to D⁴. By means of the pyramid encoder 710 a pyramid of features Φ₀¹ to Φ₀⁴ and Φ₁¹ to Φ₁⁴ is extracted from input (reference) frames I₀ and I₁, respectively. Each pyramid level is characterized by a different resolution, i.e., number of feature channels corresponding to gradually decimated spatial sizes. Intermediate flow fields F¹_{t→0} to F³_{t→0} and F¹_{t→1} to F³_{t→1} are gradually refined through the multiple decoders 720, D¹ to D⁴ by backward warping the features Φ₀¹ to Φ₀⁴ and Φ₁¹ to Φ₁⁴ to generate intermediate features [symbol] to [symbol] and [symbol] to [symbol] according to F¹_{t→0} to F³_{t→0} and F¹_{t→1} to F³_{t→1}. The bilateral intermediate flow fields F¹_{t→0} to F³_{t→0} and F¹_{t→1} to F³_{t→1} can be jointly refined together with reconstructed intermediate features [symbol] to [symbol] provided by the decoders 720, D¹ to D⁴ until the highest level of the pyramid which yields the final output frame Iₜ. Further details can be found in the paper by L. Kong et al. cited above.

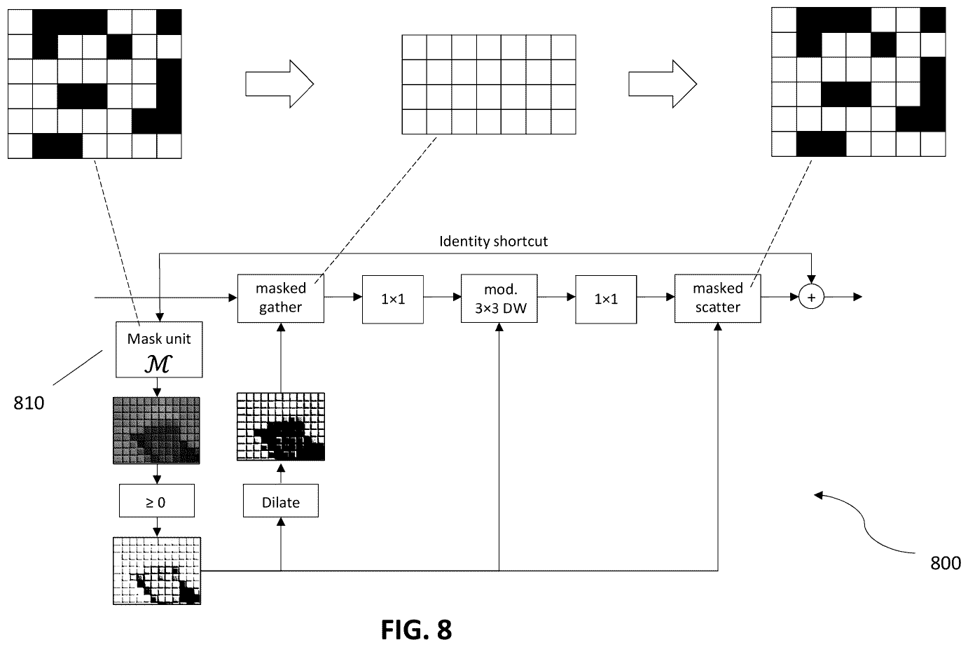

FIG. 8 illustrates the dynamic convolution architecture 800 introduced by T. Verelst and T. Tuytelaars. Convolutional processing in the spatial domain is conditionally applied. Dynamic convolutions comprise a residual block with a learnable mask unit 810) that learns which spatial positions should be processed. The gating decisions serving as execution masks are trained end-to-end and the level of sparsity can be added to the loss function along with the fidelity of the output. The convolutions are dynamically applied conditioned on the input image. First, the mask unit 810 generates a mask (gating decisions) based on the input. The gating decisions indicate positions where the spatial 3×3 convolutions should be applied. The mask is morphologically dilated to avoid gaps. Then, a gather operation copies the elements corresponding to active positions in the mask to a new intermediate tensor. Non-spatial operations such as activation functions and pointwise 1×1 convolutions can be efficiently executed on the intermediate tensor while spatial operations such as regular 3×3 convolutions need small adaptations to map back to the original spatial pixel locations. Before making the residual summation, a scatter operation is used to copy back the results to their original locations. Further details can be found in the paper by T. Verelst and T. Tuytelaars cited above.

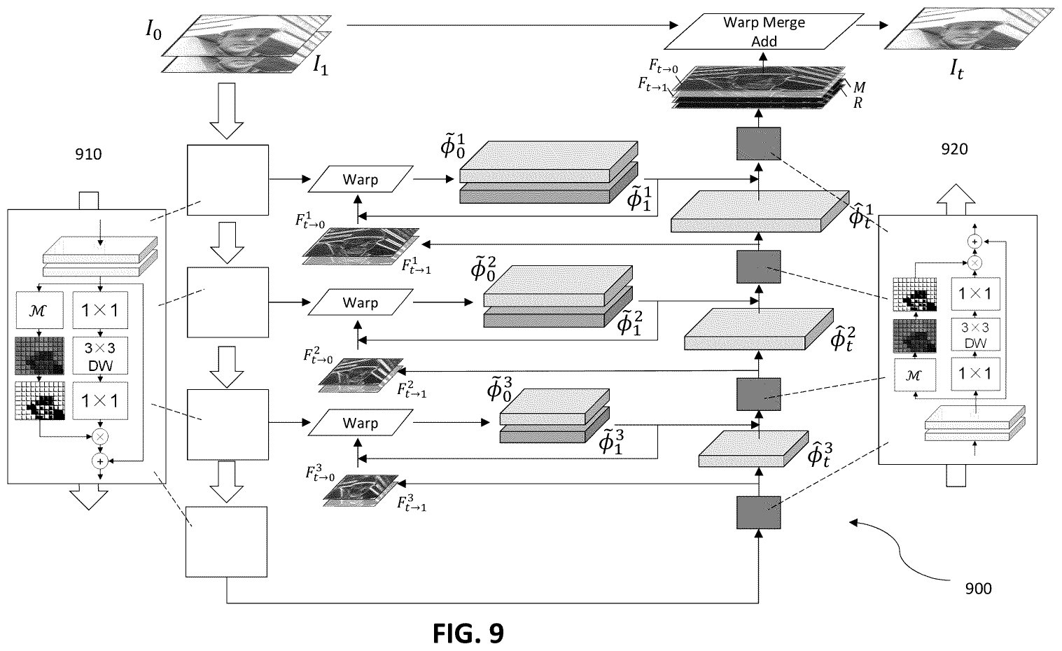

FIG. 9 illustrates the architecture of a processing apparatus 900 according to an embodiment. The processing apparatus 900 may be a video encoder device or a video decoder device. The processing apparatus 900 comprises the convolutional neural network architecture for intermediate video frame synthesis illustrated in FIG. 7 and implements dynamic convolutions as illustrated in FIG. 8. The resulting architecture may be addressed as a sparsified IFRNet architecture.

The processing apparatus 900 takes two video frames I₀ and I₁ with dimensions W×H×3 and time steps 0 and t=1 as inputs and outputs an intermediate frame with dimensions W×H×3 at intermediate time step t ϵ [0, 1]. The processing apparatus 900 comprises a (sparse) pyramid encoder 910 and a (sparse) decoder 920 comprising coarse-to-fine decoders for each pyramid level. Each pyramid level is characterized by a different resolution, i.e., number of feature channels corresponding to gradually decimated spatial sizes. For example, four pyramid levels with 32, 48, 72 and 96 feature channels, respectively, are employed. Each encoder level may consist of a block of two 3×3 convolutions with strides 2 and 1. Each convolution is followed by a PRELU activation function. Intermediate flow fields F¹_{t→0} to F³_{t→0} and F¹_{t→1} to F³_{t→1} are gradually refined through the decoder 920 by backward warping the features provided by the pyramid encoder 910 to generate intermediate features [symbol] to [symbol] and [symbol] to [symbol] according to F¹_{t→0} to F³_{t→0} and F¹_{t→1} to F³_{t→1}. The bilateral intermediate flow fields F¹_{t→0} to F³_{t→0} and F¹_{t→1} to F³_{t→1} can be jointly refined together with reconstructed intermediate features [symbol] to [symbol] provided by the decoder 910 until the highest level of the pyramid which yields the final output frame Iₜ.

The final output frame Iₜ can be placed in a Decoded Picture Buffer, for example. For example, the buffered output frame Iₜ can be used for intra prediction or inter prediction coding. According to another example, the output frame Iₜ can be used for frame-rate up conversion purposes, for example, frame-rate up conversion by a video decoder device.

On the decoder side 920, intermediate flows are gradually refined by backward warping the extracted pyramid features. Each of the coarse-to-fine decoders of the decoder 920 outputs a higher level reconstructed intermediate feature and bilateral flow fields. Each level of the decoder 920 may consist of a block of six 3×3 convolutions and one 4×4 deconvolution with strides 1 and ½ and residual connections. The residual connection is added between the output of the first convolution and the sixth convolution of each block. Each convolution is followed by a PRELU activation function.

Different from the architecture 700 of the art illustrated in FIG. 7 some convolutional blocks in the encoder 710 and the decoders 720 are replaced for sparsification of the data to be processed in the processing apparatus 900 of the embodiment shown in FIG. 9. For example, every second convolutional block used in IFRNet may be replaced with a dynamic convolution block in the encoder 910 of the processing apparatus 900 and on the decoder side 920 the convolutions of each residual block (second to sixth convolutions) are replaced with three consecutive dynamic convolutions. For example, each dynamic convolution block comprises a mask unit, a gather unit, a 1×1 convolution unit, a 3×3 depth-wise convolution unit, another 1×1 convolution unit and a scatter operation unit. Additionally, convolution is followed by a batch norm ReLU activation function (cf. FIG. 8 and description thereof).

In principle, the (content based) trained mask unit may be applied pixelwise to the input video frames I₀ and I₁ or in latent space (to feature tensors) and application of the mask unit results in sparsified data wherein sub-portions of the input video frames I₀ and I₁ that are not of relevance (for example, static objects or background) are excised from the further processing.

A set of networks can be trained each one being optimized for a different sparsity level indicating the relative reduction of data as compared to the original input frames. The sparsity level may indicate the overall percentage of convolution positions to be skipped, e.g. the relative number of zeros in the sparsification mask unit. Since the trained sparsified IFRNets have identical structure switching between different sparsity levels can be achieved by changing the weights in the network, using one of the pre-trained sets of weights. The set of networks can be trained to skip some convolutional positions/filter applications according to the content of the input data. During inference the optimal sparsity level can be selected for the actual application/data input in order to accordingly adapt the computational load of the overall coding process. Based on the selected sparsity level (target sparsity) the corresponding pre-trained neural network can be used.

The decision on the sparsity level to be used needs to be known both on a video encoder device side and a video decoder device side. According to different embodiments, explicit sparsity level selection, estimated sparsity level selection and implicit sparsity level selection are provided.

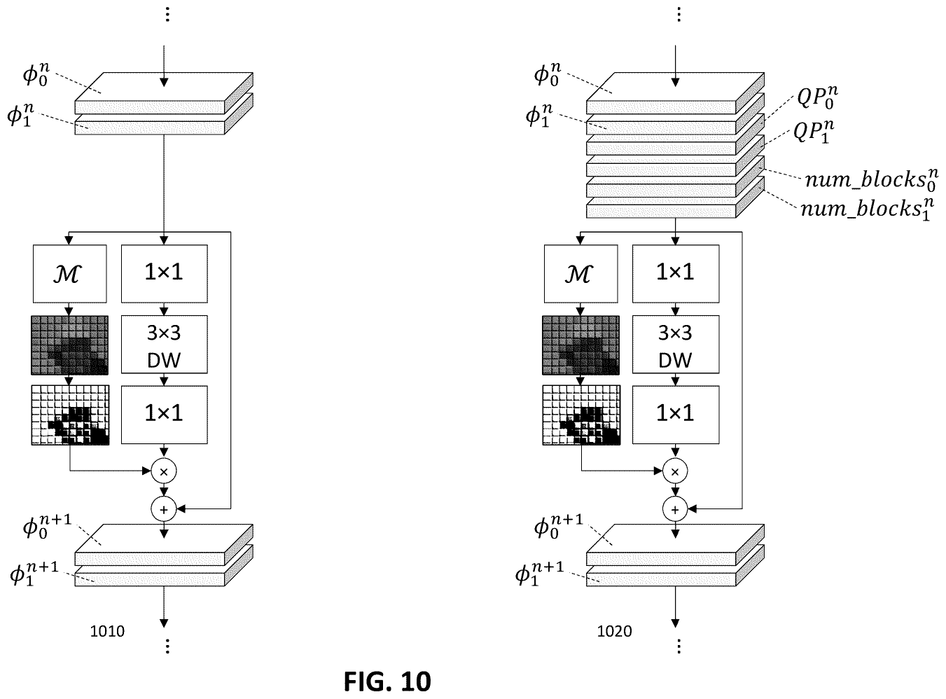

In the case of explicit sparsity level selection and estimated sparsity level selection a set of neural networks comprising the neural network 910 and 1010 comprising the mask unit shown in FIGS. 9 and 10 (left-hand side) is trained for different sparsity levels. Sparsity levels between 10% and 90%, for example, between 20% and 80% sparsity of the data to be further processed with respect to the input video frames might be chosen based on empirical findings, wherein neighbored sparsity levels are spaced with respect to each other by intervals of at least 10% sparsity. A large range of sparsity levels can be covered, wherein intervals significantly smaller than 10% would not increase accuracy of frame synthesis given limited matching of target sparsity levels during the training process. In the case of explicit sparsity level selection, a video encoder device decides on the actually to be employed target sparsity and signals the target sparsity together with the usual video stream metadata to a video decoder device. Decision on the target sparsity and signaling of the same may be performed on a per-frame basis. Upon reception of the signaled target sparsity the video decoder device knows how to synthesize intermediate frame and knows which set of weights to be used in the sparsified network for the synthesis. Based on explicit selection, the sparse IFRNet architecture can be applied to a wide variety of video compression schemes.

According to estimated sparsity level selection, also a set of neural networks comprising the neural network 910 and 1010 comprising the mask unit shown in FIGS. 9 and 10 (left-hand side) is trained for different sparsity levels. However, the actually used target sparsity is not selected by the video encoder device and signaled to the video decoder device but rather it is estimated on both the video encoder device side and the video decoder device. Both the video encoder device and the video decoder device will come to the same result since they will use the same estimation algorithm.

According to an embodiment, the target sparsity is estimated based on a quantization parameter and/or an number of partitioning blocks into which the input video frames are partitioned.

The larger the quantization parameter is, the harsher the compression is and, consequently, the smoother the image is. A smoother image is easier to process, does not require so many samples, and can be reliably processed using a higher sparsity level. During compression, the image is split into blocks, and those can have variable sizes depending on the content—smoother regions are typically encoded using larger blocks, and high density, high contrast textures typically demand for partitioning into smaller blocks. Thus, a low number of blocks indicates a smoother and easier to process image allowing for high sparsity levels.

According to a particular embodiment, the target sparsity is estimated both on the video encoder device side and the video decoder device side based on the equation

$${SR}_{estimated} = k ( \frac{{NB}_{0}^{n} + {NB}_{1}^{n}}{2 {NB}_{max}} ) + ( {SR}_{max} - k ) ( \frac{{QP}_{0}^{n} + {QP}_{1}^{n}}{2 {QP}_{max}} )$$

Wherein SR_{estimated} is the estimated target sparsity,

$${NB}_{0}^{n} , {NB}_{1}^{n}$$

is the number of blocks into which the first and second video frames are partitioned, respectively, NBₘₐₓ is the maximum possible number of blocks into which the first and second video frames can be partitioned depending on the resolution of the first and second video frame and possible block sizes, SRₘₐₓ is a pre-defined maximum target sparsity level (for example, SRₘₐₓ=0.8 or 0.9),

$${QP}_{0}^{n} + {QP}_{1}^{n}$$

are the quantization parameter values for the first and the second video frames, respectively, QPₘₐₓ is a pre-defined maximum quantization parameter value and k is a pre-defined weighting coefficient (for example, between 0 and 1).

The coefficient k is experimentally selected according to the proportional contribution of the mean quantization parameter and mean number of partitioning blocks for the two input reference frames. As the quantization parameters and block partitioning changes from frame to frame a list of previously used quantization parameters and block partitions may be kept for each reference picture. The estimated sparsity level selection allows for straightforward computation and does not need any signaling of the target sparsity.

According to implicit sparsity level selection, the target sparsity is also determined on both the video encoder side and the video decoder side without signaling but based on an implicitly sparsified neural network 1020 (see right-hand side of FIG. 10). In this case, different sparsity levels are achieved not by training separate networks, one for each sparsity level, but rather by providing control parameters as additional input and training the neural network (a.k.a. conditioning the network) to adapt to the chosen control parameters on the fly. Again, the previously calculated quantization parameters and block partition numbers are kept attached to each reference picture from the reference picture list. To achieve the conditioning,

$${NB}_{0}^{n} , {NB}_{1}^{n} , {QP}_{0}^{n} , {QP}_{1}^{n}$$

are provided as a side channel to each dynamic convolution as shown it is shown in FIG. 10 (right-hand side). This approach is harder to train as compared to the explicit and estimated sparsity level selections described above, but allows operation without the need to update the neural network weights on the fly. It also allows the network to adapt its sparsification to the actual contents of the reference frames rather than to the mean values only.

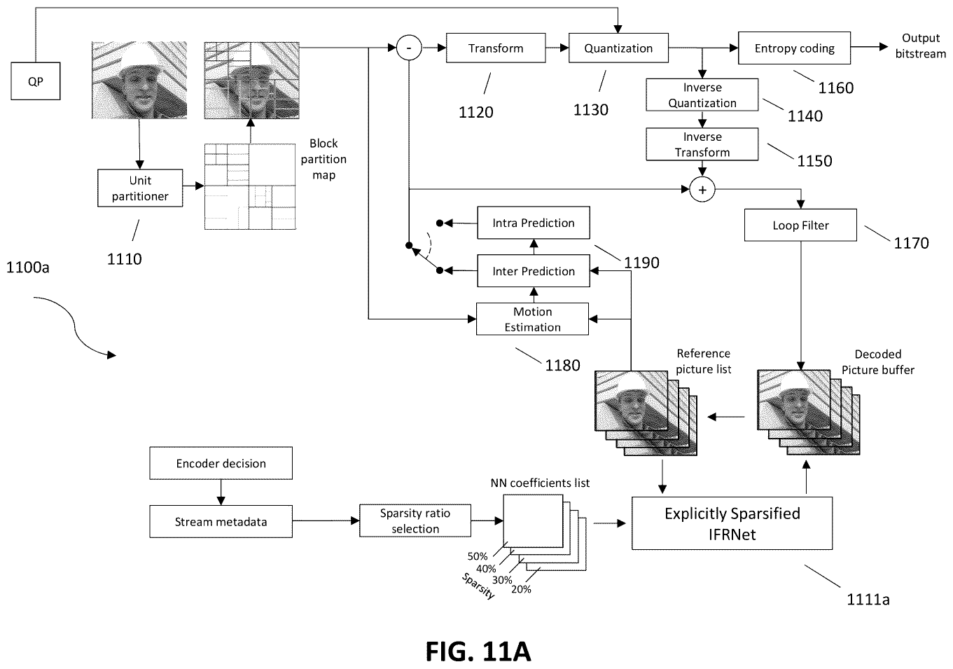

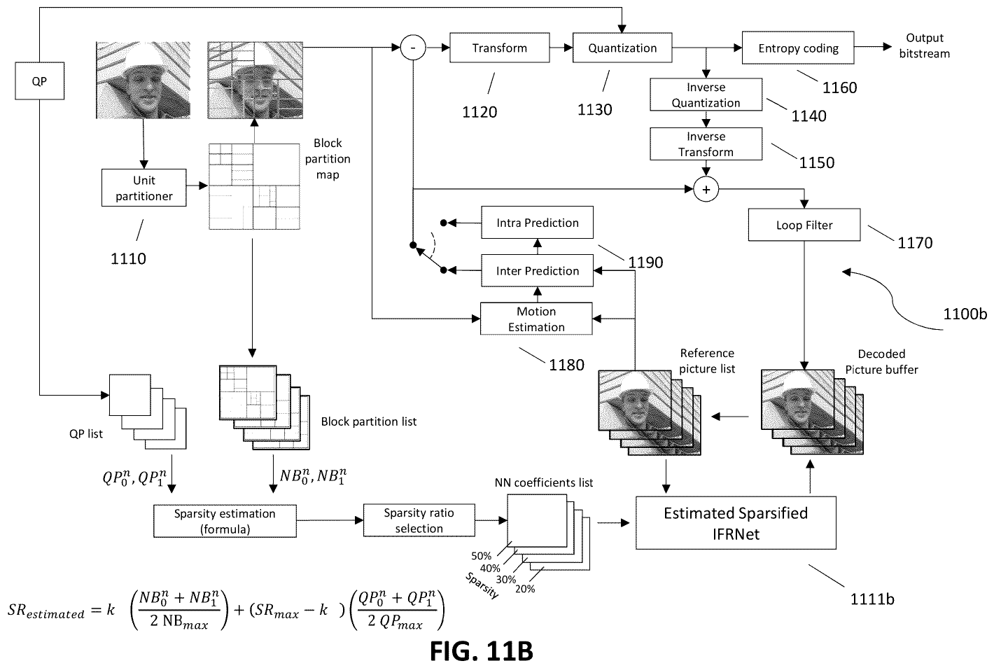

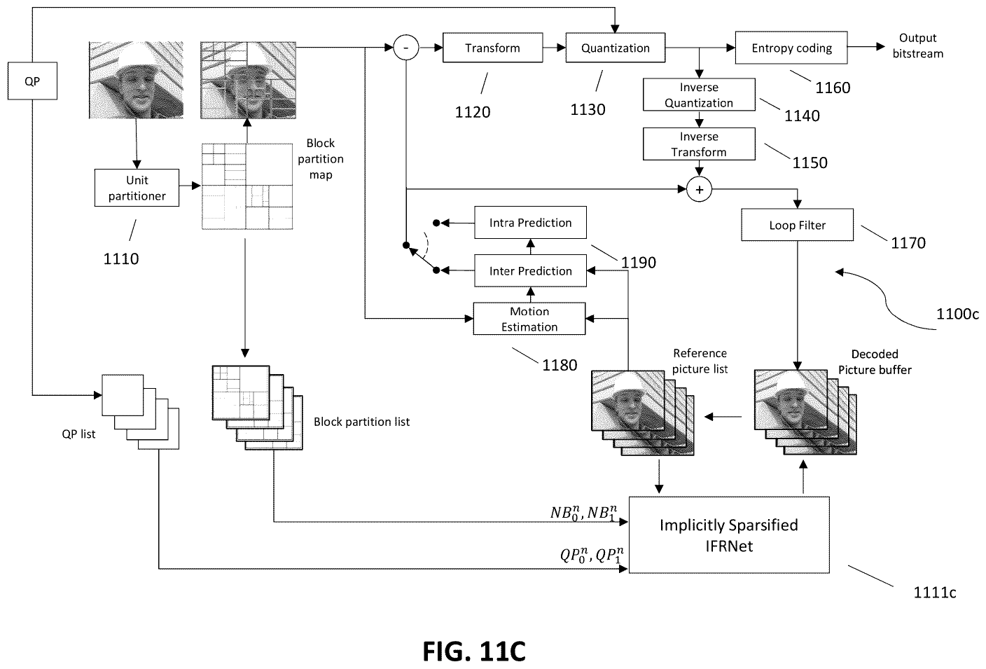

FIGS. 11A to 11C illustrate embodiments of a processing apparatus (for example, a video encoder device or a video decoder device) comprising a convolutional neural network architecture for intermediate video frame synthesis based on hybrid video codecs and implementing dynamic convolutions according to explicit (FIG. 11A), estimated (FIG. 11B) and implicit (FIG. 11C) sparsity level selection, respectively.

All of the processing apparatuses 1100a, 1100b and 1100c shown in FIGS. 11A, 11B and 11C comprise a partitioning unit 1110, a transform unit 1120, a quantization unit 1130, an inverse quantization unit 1140, an inverse transform unit 1150, an entropy coding unit 1160, a loop filter 1170, a motion estimation unit 1180 and a prediction unit 1190 for selective intra or inter prediction.

The processing apparatus 1100a shown in FIG. 11A comprises an explicitly sparsified IFRNet 1111a, i.e., an IFRNet implementing the explicit sparsity level selection described above. Based on an encoder decision on a video encoder device side (or a decision by a different unit of the video encoder device) a particular sparsity level/ratio is selected and signaled to a video decoder device. The explicitly sparsified IFRNet 1111a is one of a set or pre-trained neural networks (trained for a plurality of different sparsity levels) that is selected based on the particular sparsity level/ratio selected by the encoder. Reference frames are input into the explicitly sparsified IFRNet 1111a and processed in order to obtain a synthesized intermediate video frame as described above and to be stored to a Decoded Picture Buffer and/or a Reference Picture List for further usage (for example, prediction or frame rate up-conversion).

The processing apparatus 1100b shown in FIG. 11B comprises an estimated sparsified IFRNet 1111b implementing the estimated sparsity level selection described above. The sparsity level is estimated based on a sparsity formula, for example, the above described equation for SR_{estimated}. The actually employed target sparsity is selected based on the estimation result. The estimated sparsified IFRNet 111b is one of a set or pre-trained neural networks (trained for a plurality of different sparsity levels) that is selected based on the particular target sparsity resulting from the estimate. Reference frames are input into the estimated sparsified IFRNet 1111b and processed in order to obtain a synthesized intermediate video frame as described above and to be stored to a Decoded Picture Buffer and/or a Reference Picture List for further usage (for example, prediction or frame rate up-conversion).

The processing apparatus 1100c shown in FIG. 11C comprises an implicitly sparsified IFRNet 1111c implementing the implicit sparsity level selection described above. For each input frame a quantization parameter and a partitioning block number are input as a side channel into the implicitly sparsified IFRNet for on the fly training/provision of the suitable target sparsity. Reference frames are input into the implicitly sparsified IFRNet 1111c and processed in order to obtain a synthesized intermediate video frame as described above and to be stored to a Decoded Picture Buffer and/or a Reference Picture List for further usage (for example, prediction or frame rate up-conversion).

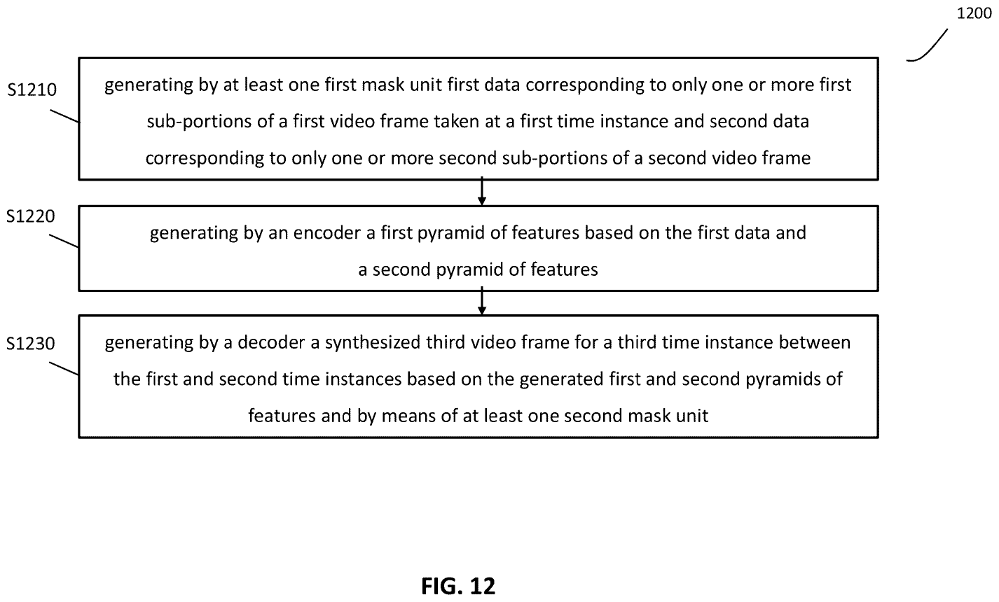

FIG. 12 is a flow chart illustrating a method 1200 of video frame synthesis by means of a convolutional neural network according to an embodiment. The convolutional neural network comprises an encoder and a decoder, wherein the encoder comprises at least one first mask unit and the decoder comprises at least one second mask unit. The method 1200 includes the steps of: generating by the at least one first mask unit first data corresponding to only one or more first sub-portions of a first video frame taken at a first time instance and second data corresponding to only one or more second sub-portions of a second video frame taken at a second time instance different from the first time instance, generating by the encoder a first pyramid of features based on the first data and a second pyramid of features based on the second data and generating by the decoder a synthesized third video frame for a third time instance between the first and second time instances based on the generated first and second pyramids of features and by means of the at least one second mask unit. The method 1200 can be implemented in a video encoder device or a video decoder device. In particular, the method 1200 can be implemented in any of the processing apparatuses 900, 1100a. 1100b and 1100c shown in FIGS. 9, 11A. 11B and 11C, respectively. For example, a system configured to perform image compression, e.g., the neural network of FIG. 1 can perform the steps of the method 1200.

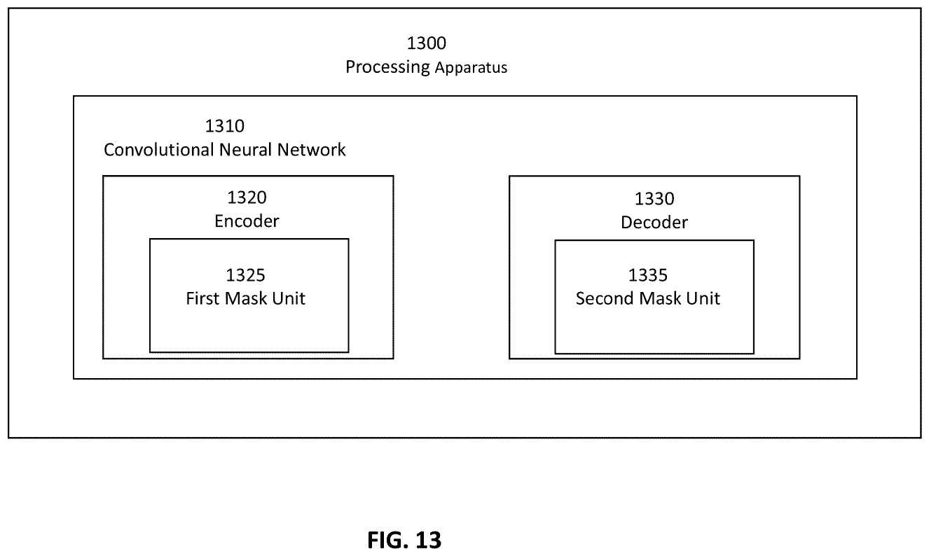

Furthermore, the method 1200 may be implemented in the processing apparatus 1300 for video frame synthesis illustrated in FIG. 13. The processing apparatus 1300 (for example, a video encoder device or a video decoder device) comprises a convolutional neural network 1310. The convolutional neural network 1310 comprises an encoder 1320 and a decoder 1330, the encoder 1320 comprising at least one first mask unit 1325 and the decoder 1330 comprising at least one second mask unit 1335. The at least one first mask unit 1325 is configured for generating first data corresponding to only one or more first sub-portions of a first video frame taken at a first time instance and second data corresponding to only one or more second sub-portions of a second video frame taken at a second time instance different from the first time instance. The encoder 1320 is configured for generating a first pyramid of features based on the first data and a second pyramid of features based on the second data and the decoder 1330 is configured for generating a synthesized third video frame for a third time instance between the first and second time instances based on the generated first and second pyramids of features and by means of the at least one second mask unit 1335.

The processing apparatus 13 may comprise any of the processing apparatuses 900, 1100a, 1100b and 1100c shown in FIGS. 9, 11A, 11B and 11C, respectively.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### Some Exemplary Implementations in Hardware and Software

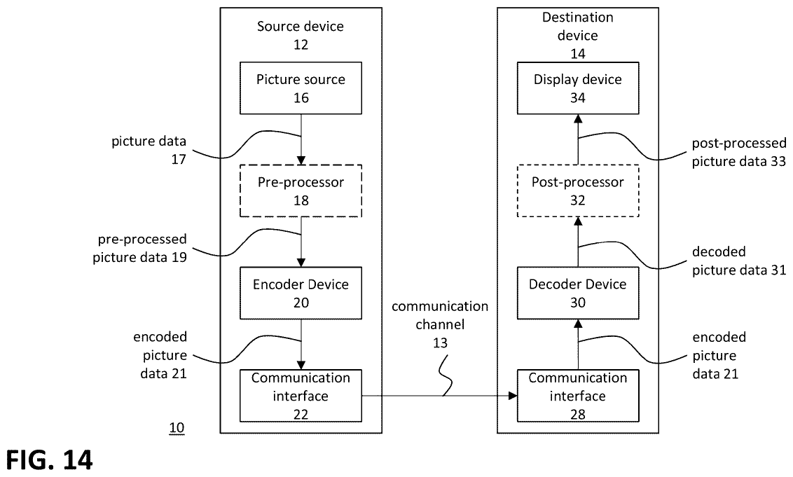

The corresponding system which may deploy the above-mentioned encoder-decoder processing chain is illustrated in FIG. 14. FIG. 14 is a schematic block diagram illustrating an example coding system, e.g. a video, image, audio, and/or other coding system (or short coding system) that may utilize techniques of this present disclosure. Video encoder device 20 (or, in the following, shorter encoder 20) and video decoder device 30 (or, in the following, shorter decoder 30) of video coding system 10 represent examples of devices that may be configured to perform techniques in accordance with various examples described in the present disclosure. For example, the video coding and decoding may employ neural network such which may be distributed and which may apply the above-mentioned bitstream parsing and/or bitstream generation to convey feature maps between the distributed computation nodes (two or more).

As shown in FIG. 14, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 14 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 14 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 14 may vary depending on the actual device and application.

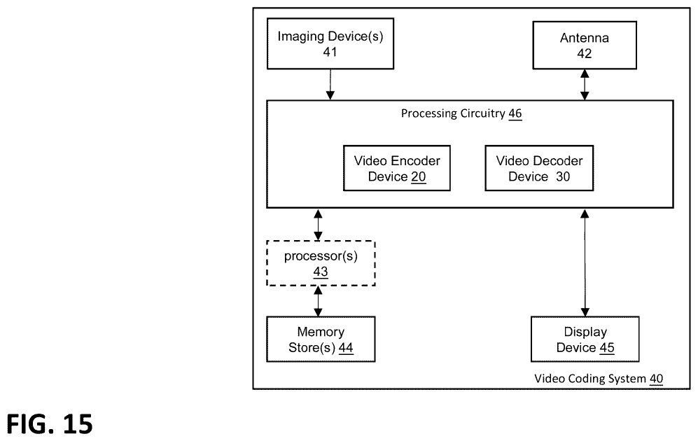

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 15.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 14 is merely an example and the techniques of the present disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

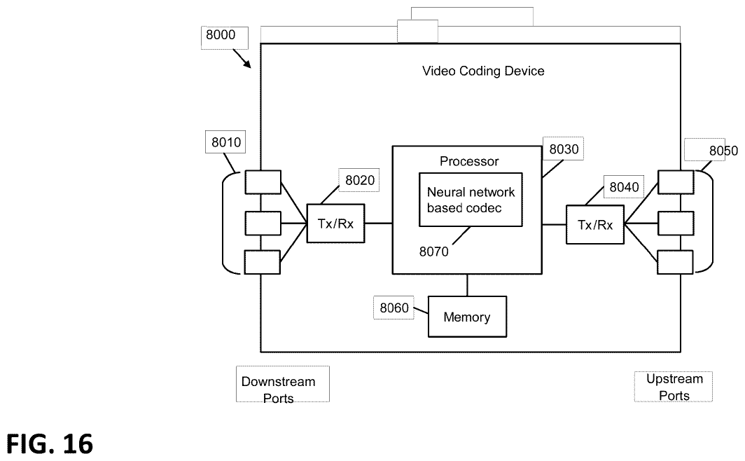

FIG. 16 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 14 or an encoder such as video encoder 20 of FIG. 14.

The video coding device 8000 comprises ingress ports 8010 (or input ports 8010) and receiver units (Rx) 8020 for receiving data: a processor, logic unit, or central processing unit (CPU) 8030 to process the data: transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAS, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

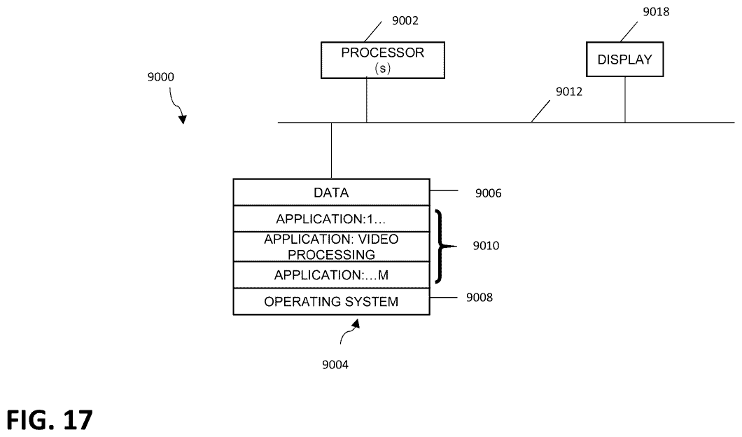

FIG. 17 is a simplified block diagram of an apparatus that may be used as either or both of the source device 12 and the destination device 14 from FIG. 14 according to an embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

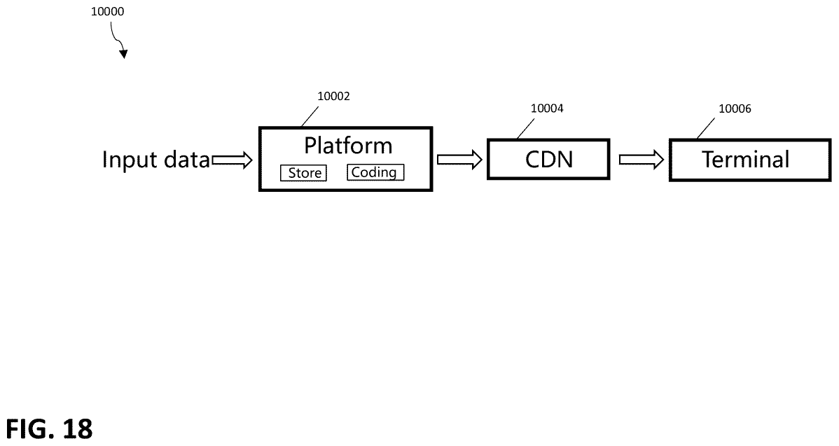

FIG. 18 is a block diagram of a video coding system 10000 according to an embodiment of the disclosure.

A platform 10002 in the system 10000 can be could sever or local sever. Alternatively, the platform 10002 can be any other type of device, or multiple devices, capable of calculation, storing, transcoding, encryption, rendering, decoding or encoding. Although the disclosed implementations can be practiced with a single platform as shown, e.g., the platform 10002, advantages in speed and efficiency can be achieved using more than one platform.

A content delivery network (CDN) 10004 in the system 10000 can be a group of geographically distributed servers. Alternatively, the CDN 10004 can be any other type of device, or multiple devices, capable of data buffering, scheduling, dissemination or speed up the delivery of web content by bringing it closer to where users are. Although the disclosed implementations can be practiced with a single CDN as shown, e.g., the CDN 10004, advantages in speed and efficiency can be achieved using more than one CDN.

A terminal 10006 in the apparatus 10000 can be a mobile phone, computer, television, laptop, camera. Alternatively, the terminal 10006 can be any other type of device, or multiple devices, capable of displaying video or image.

What is claimed is:

1. A method of video frame synthesis, applied to a convolutional neural network comprising an encoder and a decoder, wherein the encoder comprises at least one first mask component and the decoder comprises at least one second mask component, the method comprises:
generating, by the at least one first mask component, first data corresponding to only one or more first sub-portions of a first video frame taken at a first time instance and second data corresponding to only one or more second sub-portions of a second video frame taken at a second time instance different from the first time instance;
generating, by the encoder, a first pyramid of features based on the first data and a second pyramid of features based on the second data; and
generating, by the at least one second mask component of the decoder, a synthesized third video frame for a third time instance between the first and second time instances based on the generated first and second pyramids of features.

2. The method according to claim 1, wherein the at least one first and second mask components are trained for obtaining a target sparsity of the first data with respect to the first video frame and the second data with respect to the second video frame.

3. The method according to claim 2, wherein the at least one first mask component and the at least one second mask component are trained based on content of training images.

4. The method according to claim 2, further comprising determining the target sparsity based on a quantization parameter used for compressing the first and second video frames.

5. The method according to claim 2, wherein the target sparsity depends on at least one of: a number of objects present in the first and second video frames, a degree of motion of the objects between the first and second video frames, a number of image partitions into which the first and second video frames are partitioned, and a level of compression of the first and second video frames.

6. The method according to claim 2, further comprising selecting the target sparsity out of a plurality of pre-defined target sparsity levels by a video encoder device comprising copies of the convolutional neural network for each of the pre-defined target sparsity levels, signaling the selected target sparsity to a video decoder device comprising copies of the convolutional neural network for each of the pre-defined target sparsity levels and processing, by the video decoder device, the first and second video frames based on the signaled target sparsity.

7. The method according to claim 2, further comprising determining the target sparsity by a video encoder device comprising copies of the convolutional neural network for each of pre-defined target sparsity levels and by a video decoder device comprising copies of the convolutional neural network for each of pre-defined target sparsity levels based on at least one of a) a quantization parameter used for compression of the first and second video of frames and b) a number of blocks into which the first and second video frames are partitioned.

8. The method according to claim 7, wherein the target sparsity level SR_{estimated} is determined by the video encoder device and the video decoder device based on the following:
$${SR}_{estimated} = k ( \frac{{NB}_{0}^{n} + {NB}_{1}^{n}}{2 {NB}_{max}} ) + ( {SR}_{max} - k ) ( \frac{{QP}_{0}^{n} + {QP}_{1}^{n}}{2 Q {P}_{max}} )$$
wherein
$${NB}_{0}^{n} , {NB}_{1}^{n}$$
to which the first and second video frames are partitioned, respectively, NBₘₐₓ is the maximum possible number of blocks into which the first and second video frames can be partitioned depending on the resolution of the first and second video frame and possible block sizes, SRₘₐₓ is a pre-defined maximum target sparsity level,
$${QP}_{0}^{n} + {QP}_{1}^{n}$$
are the quantization parameter values for the first and the second video frames, respectively, QPₘₐₓ is a pre-defined maximum quantization parameter value and k is a pre-defined weighting coefficient.

9. The method according to claim 6, wherein the plurality of pre-defined target sparsity levels comprises a number of sparsity levels between 10% and 90% sparsity of the first data with respect to the first video frame and the second data with respect to the second video frame, wherein neighbored sparsity levels are spaced with respect to each other by intervals of at least 10% sparsity of the first data with respect to the first video frame and the second data with respect to the second video frame.

10. The method according to claim 2, further comprising
receiving, by the at least one first mask component, at least one of a) a quantization parameter used for compression of the first and second video of frames and b) a number of blocks into which the first and second video frames are partitioned; and
determining, by the at least one first mask component, the target sparsity based on the received at least one of a) the quantization parameter used for compression of the first and second video of frames and b) the number of blocks into which the first and second video frames are partitioned.

11. The method according to claim 1, wherein generating the synthesized third video frame comprises conjointly refining bilateral intermediate flow fields together with a first intermediate pyramid of features reconstructed based on the first pyramid of features and a second intermediate pyramid of features reconstructed based on the second pyramid of features.

12. A method of video compression comprising the method according to claim 1, wherein the synthesized third video frame is saved as an S frame in a decoded picture buffer or is added to a list of reference pictures used for intra prediction or inter prediction.

13. A method of frame rate up-conversion comprising the method according to claim 1, wherein the synthesized third video frame is used for increasing a frame rate of a transmitted video comprising the first and second video frames.

14. A non-transitory computer-readable medium comprising computer programs, which upon being executed on one or more processors, cause the one or more processors to perform the method according to claim 1.

15. A processing apparatus for video frame synthesis comprising a convolutional neural network, wherein
the convolutional neural network comprises an encoder and a decoder, the encoder comprising at least one first mask component and the decoder comprising at least one second mask component;
the at least one first mask component is configured to generate first data corresponding to only one or more first sub-portions of a first video frame taken at a first time instance and second data corresponding to only one or more second sub-portions of a second video frame taken at a second time instance different from the first time instance;
the encoder is configured to generate a first pyramid of features based on the first data and a second pyramid of features based on the second data; and
the at least one second mask component of the decoder is configured to generate a synthesized third video frame for a third time instance between the first and second time instances based on the generated first and second pyramids of features.

16. The processing apparatus according to claim 15, wherein the at least one first and second mask components are trained for obtaining a target sparsity of the first data with respect to the first video frame and the second data with respect to the second video frame.

17. A video encoder device comprising copies of the processing apparatus according to claim 16, each of the copies comprising the convolutional neural network for a different one of pre-defined target sparsity levels, wherein the video encoder device is configured to select the target sparsity out of the plurality of pre-defined target sparsity levels and signaling the selected target sparsity to a video decoder device.

18. A video decoder device comprising copies of the processing apparatus according to claim 16, each of the copies comprising the convolutional neural network for a different one of pre-defined target sparsity levels, wherein the video decoder device is configured to process the first and second video frames based on a target sparsity received from an encoder device.

19. A video encoder device comprising copies of the processing apparatus according to claim 16, each of the copies comprising the convolutional neural network for a different one of pre-defined target sparsity levels, wherein the video encoder device is configured to determine the target sparsity based on at least one of a) a quantization parameter used for compression of the first and second video of frames and b) a number of blocks into which the first and second video frames are partitioned.

20. A video decoder device comprising copies of the processing apparatus according to claim 16, each of the copies comprising the convolutional neural network for a different one of pre-defined target sparsity levels, wherein the video encoder device is configured to determine the target sparsity based on at least one of a) a quantization parameter used for compression of the first and second video of frames and b) a number of blocks into which the first and second video frames are partitioned.
